(19) United States
(12) Patent Application Publication
(10) Pub. No.: US 2005/0180140 A1
(43) Pub. Date: Aug. 18, 2005

(54) Intense pulsed light devices

(76) Inventors: David S George, Swansea (GB); Dennis A Briaris, Swansea (GB)

Correspondence Address: BAKER & DANIELS LLP, 300 NORTH MERIDIAN STREET, SUITE 2700, INDIANAPOLIS, IN, 46204, US

(21) Appl. No.: 10/513,843

(22) PCT Filed: May 7, 2003
(86) PCT No.: PCT/GB03/01972

(30) Foreign Application Priority Data
May 7, 2002 (GB) 0210302.6

(51) Int. Cl. F21V 1/00

(52) U.S. Cl. 362/277

(57) ABSTRACT

An intense pulsed light (IPL) device includes a housing (1) for supporting a light emitting source in light transmitting relationship with a light coupler (5). The light coupler has an input end (5a) for receiving light from the source to and an output end (5b) adapted to pass light towards a surface or a region to be treated. The light coupler and the source (2) are mounted in the housing to allow adjustable movement of one relative to the other thereby to allow adjustment of the output energy of the light passing from the coupler (5).

This invention relates to intense pulsed light (IPL) devices of the type which may be used in a variety of applications, including for therapeutic purposes for treating e.g. vascular problems, or for cosmetic purposes such as hair depilation, or photo-rejuvenation where electromagnetic energy is provided in pulsed sequence to an area of the body of a human or animal to be treated.

Such devices typically use a mechanism known as photothermolysis in which certain materials (chromophores) in the skin are selectively heated using light energy.

IPL devices such as those described in U.S. Pat. No. 5,683,380 use a light coupler to couple light from the light source to the skin, either with or without the use of filters for restricting the electromagnetic radiation to certain wavelengths or bands of wavelengths typically in the range of from 495 nm to 1200 nm. Typical energies of these devices can be anything between 5 to 100 joules/cm². Energies above 30 joules/cm² are enough to cause burning of live skin tissue such that the timing, duration and strength of these intense pulses of light needs to be accurately determined if burn injuries are to be avoided. This can be particularly serious when treating certain types of skin, such as Asian skin, and can even lead to scarring.

Despite the foregoing, a problem arises in connection with variation of the energy output of nominally identical IPL devices due to a number of factors. A significant factor is that the flashlamp comprises a Xenon (or other gas) filled glass tube having an anode and cathode at respective ends and which is sealed against the atmosphere by melting the glass in these regions and allowing it to cool. This process may require the expertise of a skilled glass blower in order to achieve a satisfactory seal at both ends of the tube. As a result of this mode of manufacture, variations in length between the anode and cathode can occur, as well as variations in the volume of the tube and hence the amount of Xenon (or other) gas present within the tube, such that the impedance of the flashlamp and hence the output energy can change from a desired standard. Therefore, variations in power output are a consequence of this mode of manufacture. This problem is exacerbated by variations which occur in other components of such devices including optical filters, reflectors and couplers, as well as electrical energy sources such as capacitor banks.

Optical filters used to provide suitable wavelengths of light, often have manufacturing tolerances where the wavelength can vary by typically up to plus or minus 15 nanometres. Polishing tolerances can alter the thickness of the filter by typically plus or minus 0.2 mm such that collectively variations between nominally otherwise identical filters may typically cause the optical energy output to vary by up to 5%.

Optical reflector performance depends upon the type of reflector used and manufacturing tolerances, such that anomalies in reflective properties can in turn affect the optical performance of the device, leading to variations in optical energy output of the device.

Optical coupler performance can again depend upon manufacturing tolerances in terms of dimensions, clarity of the glass and accuracy of polishing.

Electrical energy storage presents a similar problem in that e.g. capacitor bank outputs are known to vary by as much as 20% and although mechanisms can be provided to monitor the output voltage to account for any variations in the capacitors, this may not always produce the desired level of accuracy.

Collectively, all these variations mean that power output of ostensibly the same IPL devices can vary from a nominal amount by plus or minus 20%. In existing devices, an average value for the correct size and positioning of the optical coupler therefore has to be used, but erring on the side of caution, in the knowledge that overexposure of electromagnetic radiation to living tissue can cause injury.

The present invention is derived from the realisation that by varying the distance of the coupler from the flashlamp during final assembly of the device or during field use it is possible to compensate for such variations and hence calibrate successive devices within a very narrow range of power output.

According to the invention there is provided an intense pulsed light device including a housing for a flashlamp and attendant light coupler, the light input end of the coupler being disposed adjacent to the light output end of the flashlamp, the light output end of the light coupler being adapted to be placed against living tissue so as to guide pulses of light from the flashlamp thereto, characterised in that the light coupler is adjustably mounted on or in the housing to vary the distance it may be positioned from the flashlamp, to thereby enable the output energy of the coupler to be adjusted according to the distance between the input end of the coupler and the output end of the flashlamp.

Conveniently, an optical filter is mounted between the light input end of the light coupler and the light output end of the flashlamp and may be retained in place against the flashlamp by means of a flanged coupling.

The optical light coupler may be adjustably received within a sleeve which may preferably include clamp means, such as securing screws or bolts, for releasably securing the light coupler a selected distance away from the output end of the flashlamp during and following calibration of the flashlamp prior to final assembly of the device.

The invention will now be described, by way of example only, with reference to the accompanying drawings in which:

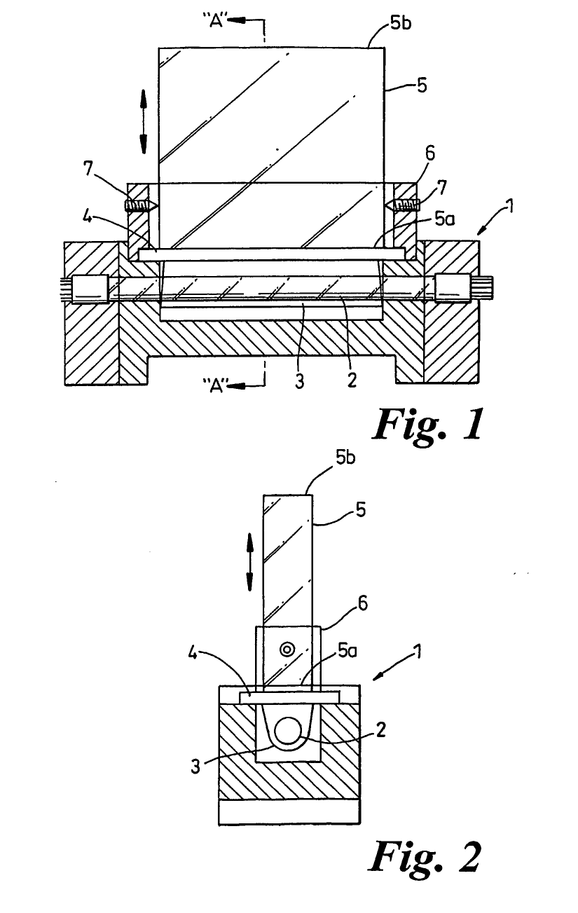

FIG. 1 is a medial cross-section of a housing for a flashlamp and attendant light coupler in accordance with this invention, and

FIG. 2 is a transverse cross-section along the lines “A-A” of FIG. 1.

Referring to the drawings there is shown generally at 1 a housing for a flashlamp 2 surrounded on three sides by a generally parabolic reflector 3, the fourth side of which provides the light output end of the flashlamp 2. An optical filter 4 is disposed over this light output end and ensures that only chosen wavelengths of light may be transmitted from the flashlamp 2 and reflector 3 to an optical coupler 5 having a light input end 5a and a light output end 5b.

Thus far the arrangement described is generally conventional but in accordance with the invention the light coupler 5 can be moved in the directions arrowed towards and away from the filter 4 at the light output end of the flashlamp 2 and attendant reflector 3. This is achieved by virtue of the light coupler 5 being received within a rectangular sleeve 6 and a pair of oppositely disposed securing screws 7 which can therefore releasably lock the light coupler 5 a chosen distance from the filter 4. In the drawing, the light coupler 5 is shown immediately adjacent to filter 4, but it will be understood that when the IPL device is being tested during calibration immediately prior to final assembly or during field calibration the light energy exiting from the light output end 5b of the light coupler 5 can be measured and if it exceeds a required threshold, for example, the light coupler can simply be moved a short distance away from the filter 4 and re-secured in position by means of the grub screws 7, whereafter a fresh reading can be taken of the power output, and the process continued until the power output is within the required tolerance band.

Since the intensity of light entering the input end 5a of the light coupler 5 is approximately inversely proportional to the square of the distance from the light from the flashlamp 2 and reflector 3, it will be understood that even a relatively small movement of the light coupler 5 will result in a significant difference in energy levels exiting from the light output end 5b. Thus although numerous optical, electronic and electro-optic factors contribute to variations in the optical power output of an IPL device, these may all be compensated by means of a simple mechanical adjustment, thereby providing a simple yet elegant solution.

Typical output parameters of an intense pulsed light device for cosmetic treatment, for example to effect hair removal are as follows:—

| | |
|---|---|
| Output energy | 5 J/cm²-100 J/cm² |
| Wavelength | 495 nm-1,200 nm |
| Spot Size | 10 mm × 50 mm, 10 mm × 25 mm, |
| | 10 mm × 10 mm |
| Pulses per Train | 1 to 17 |
| Pulse Train Length | 1 ms to 500 ms |
| Delay between pulses | 1 ms to 40 ms |
| Delay between shots | 1-20 seconds |

In practice the intense pulsed light device illustrated in the drawings is configured in a hand held tool which is connected to a base unit containing control and safety circuitry cooling devices etc by a flexible conduit. Replacement manual tools will be sold separately from the base unit and so for quality control and safety purposes, it is highly desirable that the base units provide a standard reference voltage (within an allowed tolerance) and also that the hand held tools provide a standard output energy magnitude for a given electrical input. For this purpose, the base units are calibrated before leaving the factory to have a standard output voltage. Likewise the hand held tools are calibrated using the adjustable spacing between the flashlamp and the optical coupler to ensure that, for a given voltage, the output optical energy is within an acceptable tolerance band of a target output and energy value.

This obviates having to separately calibrate each machine at the factory or on the user's premises and means that the hand held tool may be replaced at the user's premises without requiring recalibration.

1. An intense pulsed light (IPL) device including a housing (1) for supporting a light-emitting source (2) in light-transmitting relationship with a light coupler (5), said light coupler (5) having an input end (5a) for receiving light in use from said source and an output end (5b) adapted in use to pass light towards a surface or region to be treated, characterised in that the light coupler (5) and said source (2) are mounted in said housing to allow adjustable movement of one relative to the other thereby to vary the distance between the source (2) and the coupler (5), whereby to allow adjustment of the output energy of the light passing from the coupler (5) in use.

2. An IPL device according to claim 1, wherein said source (2) is a flashlamp.

3. An IPL device according to claim 1, wherein said source (2) is fixed with respect to said housing (1) and said coupler (5) is movably mounted with respect to said housing.

4. An IPL device according to claim 3, wherein said housing (1) includes a sleeve portion (6) within which said coupler (5) is slidably received, and a clamping arrangement is provided for releasably securing the coupler (5) at a selected distance from said source (2).

5. An IPL according to claim 4, wherein said clamping arrangement includes opposed threaded fixings (7).

6. An IPL according to claim 1, wherein an optical filter (4) is located in said housing between said source (2) and said coupler (5).

7. A method of adjusting the output energy of the IPL device claimed in claim 1 to calibrate the IPL device, which comprises causing said source to emit light, measuring the output energy at or adjacent the output end of the coupler (5), and adjusting the spacing between the coupler and the source to compensate for any error between the measured value of the output energy and a target value.

8. A method of cosmetic treatment of the human or animal body, which comprises applying to the area to be treated the IPL device of claim 1 and causing the source to emit light to effect cosmetic treatment of the area to be treated.

9. A method of therapeutic treatment of the human or animal body, which comprises applying to the area to be treated the IPL device of claim 1 and causing the source to emit light to effect therapeutic treatment of the area to be treated.

10. An IPL device according to claim 2, wherein said source (2) is fixed with respect to said housing (1) and said coupler (5) is movably mounted with respect to said housing.

11. An IPL device according to claim 10, wherein said housing (1) includes a sleeve portion (6) within which said coupler (5) is slidably received, and a clamping arrangement is provided for releasably securing the coupler (5) at a selected distance from said source (2).

12. An IPL according to claim 11, wherein said clamping arrangement includes opposed threaded fixings (7).

13. An IPL according to claim 3, wherein an optical filter (4) is located in said housing between said source (2) and said coupler (5).

14. An IPL according to claim 4, wherein an optical filter (4) is located in said housing between said source (2) and said coupler (5).

15. A method of adjusting the output energy of the IPL device as claimed in claim 3 to calibrate the IPL device, which comprises causing said source to emit light, measuring the output energy at or adjacent the output end of the coupler (5), and adjusting the spacing between the coupler and the source to compensate for any error between the measured value of the output energy and a target value.

16. A method of adjusting the output energy of the IPL device as claimed in claim 4 to calibrate the IPL device, which comprises causing said source to emit light, measuring the output energy at or adjacent the output end of the coupler (5), and adjusting the spacing between the coupler and the source to compensate for any error between the measured value of the output energy and a target value.

17. A method of cosmetic treatment of the human or animal body, which comprises applying to the area to be treated the IPL device according to claim 3 and causing the source to emit light to effect cosmetic treatment of the area to be treated.

18. A method of cosmetic treatment of the human or animal body, which comprises applying to the area to be treated the IPL device according to claim 4 and causing the source to emit light to effect cosmetic treatment of the area to be treated.

19. A method of therapeutic treatment of the human or animal body, which comprises applying to the area to be treated the IPL device according to claim 3 and causing the source to emit light to effect therapeutic treatment of the area to be treated.

20. A method of therapeutic treatment of the human or animal body, which comprises applying to the area to be treated the IPL device according to claim 4 and causing the source to emit light to effect therapeutic treatment of the area to be treated.
